(19) United States
(12) Patent Application Publication
(10) Pub. No.: US 2021/0201365 A1
(43) Pub. Date: Jul. 1, 2021

(54) SYSTEM AND METHODS FOR RAISING PHILANTHROPIC FUNDS

(71) Applicant: Double Good, LLC, Burr Ridge, IL (US)

(72) Inventors: Timothy Heitmann, Chicago, IL (US); Mark Biondi, Willowbrook, IL (US)

(21) Appl. No.: 17/069,695

(22) Filed: Oct. 13, 2020

Related U.S. Application Data
(63) Continuation of application No. 15/293,716, filed on Oct. 14, 2016, now abandoned.
(60) Provisional application No. 62/241,505, filed on Oct. 14, 2015.

(51) Int. Cl. G06Q 30/02

(52) U.S. Cl. CPC G06Q 30/0279; H04L 51/32

(57) ABSTRACT

An improved method of raising funds may include offering products or services from third parties for sale to support the dreams, goals or purposes of the individuals involved and may extend for an indefinite period of time, and thus may be referred to as “dreamraising.” The dreamraising platform may find use with youth and charitable organizations, in an embodiment. The dreamraising platform may create relationships between three unique roles: organizations (any organization in need of raising funds); sellers (youths or other individuals affiliated with the organization); and supporters (purchasers who purchase from the sellers). Through the platform the sellers may create an online store, in which, while setting up their pages, sellers may identify their dream (their strongly desired goal or purpose) to be displayed on their online store page. The infrastructure of the platform enables sellers to sell products or services to their community of supporters. In addition to a customized fundraising page, the seller receives access to automated marketing provided by the dreamraising platform through the use of a sidekick communication platform. The dreamraising fundraising platform, along with the sidekick communication platform, provides the seller with sophisticated digital marketing to increase sales and the ability to track funds raised.

The present application is a continuation of and claims priority to U.S. Provisional Patent Application Ser. No. 62/241,505, filed Oct. 14, 2015, and entitled “System And Methods For Raising Philanthropic Funds”. This application is hereby incorporated by reference in its entirety.

### BACKGROUND

### a. Technical Field

The instant disclosure relates to a system and methods for raising funds, including philanthropic funds, and in particular, the instant disclosure relates to a system and methods for providing a platform for others, especially youth and community organizations to assist in their efforts to raise funds.

The instant disclosure further relates to a communication tool or platform that allows the user to send out messages about his or her fundraising activities to the user's contacts, along with posting the message to the various social media platforms, while also checking on the progress of the fundraising activities. The seller may receive access to automated marketing provided by the fundraising platform through the use of the communication platform, including providing the user with sophisticated digital marketing to increase sales and the ability to track funds raised.

### b. Background Art

Fundraising for charitable, youth, and community organizations generally involves an individual going door-to-door, or reaching out to acquaintances in an unorganized fashion, to attempt to sell goods or solicit donations. Such fundraising methods are limited, however, in that the success of the fundraising campaign is necessarily limited in scope to a geographic area that can be covered by fundraisers and limited in time by the amount of time that fundraisers have available to spend on fundraising activities.

Probably the most well-known example of fundraising by a youth organization is the sale of Girl Scouts cookies each year by the Girl Scouts of the USA. Each year members of the Girl Scouts sell boxes of cookies to raise money for their troop. The members may go from door to door in their neighborhood, sell to family members, or they may sell the cookies at various places of business, usually with the help of a parent that works at that business. The sale of Girl Scouts cookies is one of the major fundraiser for local Scout units and members of the Girl Scouts have been selling cookies since 1917 to raise funds. Each year, hundreds of millions of boxes of cookies are sold to raise money for the Girl Scouts.

Other fundraising activities may involve a crowdfunding mechanism, such as Kickstarter, for example, in which fundraisers solicit cash donations for a specific purpose, sometimes in exchange for goods provided by the fundraising organization or individual. Such fundraising methods are also limited, however, in duration and scope to raising funds for a specific purpose and for a strictly defined period of time.

It would be advantageous if there was a platform that established relationships between an organization that was in need of raising funds, a seller in some way affiliated with that organization, and supporters or purchasers that would ultimately purchase goods or services from the seller. The platform would facilitate the creation of an online store by the seller, and would allow the seller to identify his or her dream, or strongly desired goal or purpose, to be displayed on the online store page. The infrastructure of the platform could enable the seller to sell products to their community of supporters.

It would further be advantageous if the platform detailed herein provided for a method of operating the fundraising platform, including the steps of generating a communication tool for participants in a particular fundraiser to share information and track sales of products or services. The communication tool would share information with parents and prospective participants in the fundraiser and the platform could utilize drip marketing to alert contacts of the fundraiser taking place. The platform could also alert the user and track sales.

It would also be advantageous if the platform detailed herein provided for a method of operating the fundraising platform, including the steps of associating a seller of a plurality of products or services with an organization, wherein neither the seller nor the organization is a source of the plurality of products or services, and providing a web page graphical user interface that lists the plurality of products or services for sale, with the web page being associated with the seller. The method may further include the step of receiving from a purchaser, an order for at least one of the plurality of products or services along with payment for the order, and the step of diverting a portion of the payment to the organization and another portion of the payment to a source of the at least one product or service.

The foregoing discussion is intended only to illustrate the present field and should not be taken as a disavowal of claim scope.

### BRIEF SUMMARY

An improved method of raising funds may include offering products or services from third parties for sale to support the dreams, goals or purposes of the individuals involved and may extend for an indefinite period of time, and thus may be referred to as “dreamraising.” The dreamraising platform may find use with youth and charitable organizations, in an embodiment. The dreamraising platform may create relationships between three unique roles: organizations (any organization in need of raising funds); sellers (youths or other individuals affiliated with the organization); and supporters (purchasers who purchase from the sellers). Through the platform the sellers may create an online store. While setting up their pages, sellers may identify their dream (their strongly desired goal or purpose) to be displayed on their online store page.

The infrastructure of the platform may enable sellers to sell products or services to their community of supporters. Through a digital connection, the community of supporters may be linked to the seller. Thus, purchases made by the seller's supporters may be attributed to the seller. The seller may allocate funds to an organization of his or her choosing or allocate the funds to himself or herself. The dreamraising platform may also promote dreamraising events, in which, through the platform, sellers, supporters and organizations can be invited to participate in live events and competitions.

Further, the dreamraising platform may promote the page on behalf of the seller to the community of supporters through professional marketing activities (either its own or using outside marking services). Organizations may be provided with the option to participate in fundraising events and/or competitions with other organizations. The platform teaches valuable life lessons such as marketing, analyzing and operating a business and encourages the desire to set and achieve goals. The platform may also generate activities and goals for the sellers, for example, sellers may be given the opportunity to participate in a 70/20/10 Spend/Save/Donate plan, where they are encouraged to donate 10% of the money they raise, save 20% of the money they raise and spend 70% of what they raise. Other goals and plans can be generated for the seller to choose.

The platform could further provide for the generation of a communication tool for participants in a particular fundraiser, with the objective to share information and track sales of products or services. At the launch of an online fundraiser, the communication tool shares information with parents and prospective participants in the fundraiser. Participants or users of the platform can login, add contacts, and share the link to the campaign fundraising page through email, text or social media. Users can also import their contacts from their email service providers, such as AOL, GOOGLE, ICLOUD, YAHOO and others. Once the contacts are imported, drip marketing can be incorporated, or a drip campaign or similar automatic email campaign can be activated, sending information to the user's contacts alerting them of the fundraiser taking place. As sales are made, the platform can alerts the user and tracks the sales. Thus, through the fundraising platform and the communication platform, the users may receive access to automated marketing, which may include sophisticated digital marketing to increase sales and sophisticated reporting providing the ability to track funds raised.

An embodiment of a method of operating a fundraising platform, including the dreamraising platform described above, may include a number of steps. The method may include associating, in a non-transitory, computer-readable memory, a seller of a plurality of products with an organization, wherein neither the seller nor organization is a source of the plurality of products and providing, based on instructions in the memory, a web page graphical user interface that lists the plurality of products for sale, the web page associated with the seller. The method may further include receiving, from a purchaser, an order for at least one of the plurality of products and payment for the order, and diverting a portion of the payment to the organization and another portion of the payment to a source of the at least one product.

Additional objectives and advantages of the present disclosure will become apparent to one having ordinary skill in the art after reading the specification in light of the drawing figures, however, the spirit and scope of the present invention, including the appended claims, should not be limited to the description of the embodiments contained herein.

### BRIEF DESCRIPTION OF THE DRAWINGS

As stated herein, the objective of the present disclosure is to provide an improved method of raising funds including a platform for offering products or services from third parties for sale to support the dreams, goals or purposes of the individuals involved and may extend for an indefinite period of time. The platform provides for relationships between organizations in need of raising funds, sellers affiliated with the organization, and supporters or purchasers who purchase from the sellers. Through the platform, the sellers create an online store in which they can identify their dreams, goals or purposes, to be displayed on their online store page.

Referring to the drawings, wherein like reference numerals refer to the same or similar features in the various views:

FIG. 1 is a block diagram and data flow view of an exemplary embodiment of a system of raising funds, including philanthropic funds.

FIG. 2 illustrates an exemplary embodiment of a graphical user interface (GUI) portion that may find use for an organization raising funds through the system of FIG. 1.

FIG. 3 illustrates an exemplary embodiment of a graphical user interface (GUI) portion that may find use for an organization raising funds through the system of FIG. 1.

FIG. 4 illustrates an exemplary embodiment of a graphical user interface (GUI) portion that may find use for an organization raising funds through the system of FIG. 1.

FIG. 5 illustrates an exemplary embodiment of a graphical user interface (GUI) portion that may find use for an organization raising funds through the system of FIG. 1.

FIG. 6 illustrates an exemplary embodiment of a graphical user interface (GUI) portion that may find use for an organization raising funds through the system of FIG. 1.

FIG. 7 illustrates an exemplary embodiment of a graphical user interface (GUI) portion that may find use for a seller raising funds through the system of FIG. 1.

FIG. 8 illustrates an exemplary embodiment of a graphical user interface (GUI) portion that may find use for a seller raising funds through the system of FIG. 1.

FIG. 9 illustrates an exemplary embodiment of a graphical user interface (GUI) portion that may find use for a seller raising funds through the system of FIG. 1.

FIG. 10 illustrates an exemplary embodiment of a graphical user interface (GUI) portion that may find use for a seller raising funds through the system of FIG. 1.

FIG. 11 illustrates an exemplary embodiment of a graphical user interface (GUI) portion that may find use for a seller raising funds through the system of FIG. 1.

FIG. 12 illustrates an exemplary embodiment of a graphical user interface (GUI) portion that may find use for a seller raising funds through the system of FIG. 1.

FIG. 13 illustrates an exemplary embodiment of a graphical user interface (GUI) portion that may find use for a seller raising funds through the system of FIG. 1.

FIG. 14 is a flow chart illustrating an exemplary embodiment of a method of raising funds with the system of FIG. 1 from the perspective of an organization raising funds.

FIG. 15 is a flow chart illustrating an exemplary embodiment of a method of raising funds with the system of FIG. 1 from the perspective of a seller raising funds.

FIG. 16 is flow chart illustrating an exemplary embodiment of a method of raising funds with the system of FIG. 1 from the perspective of a supporter or purchaser.

FIG. 17 illustrates an exemplary embodiment of a graphical user interface (GUI) portion pertaining to a communication tool that may find use for an organization raising funds through the system of FIG. 1.

FIG. 18 illustrates an exemplary embodiment of a graphical user interface (GUI) portion pertaining to a communication tool that may find use for an organization raising funds through the system of FIG. 1.

FIG. 19 illustrates an exemplary embodiment of a graphical user interface (GUI) portion pertaining to a communication tool that may find use for an organization raising funds through the system of FIG. 1.

FIG. 20 illustrates an exemplary embodiment of a graphical user interface (GUI) portion pertaining to a communication tool that may find use for an organization raising funds through the system of FIG. 1.

FIG. 21 illustrates an exemplary embodiment of a graphical user interface (GUI) portion pertaining to a communication tool that may find use for an organization raising funds through the system of FIG. 1.

FIG. 22 illustrates an exemplary embodiment of a graphical user interface (GUI) portion pertaining to a communication tool that may find use for an organization raising funds through the system of FIG. 1.

FIG. 23 illustrates an exemplary embodiment of a graphical user interface (GUI) portion pertaining to a communication tool that may find use for an organization raising funds through the system of FIG. 1.

FIG. 24 illustrates an exemplary embodiment of a graphical user interface (GUI) portion pertaining to a communication tool that may find use for an organization raising funds through the system of FIG. 1.

FIG. 25 illustrates an exemplary embodiment of a graphical user interface (GUI) portion pertaining to a communication tool that may find use for an organization raising funds through the system of FIG. 1.

FIG. 26 illustrates an exemplary embodiment of a graphical user interface (GUI) portion pertaining to a communication tool that may find use for an organization raising funds through the system of FIG. 1.

FIG. 27 illustrates an exemplary embodiment of a graphical user interface (GUI) portion pertaining to a communication tool that may find use for an organization raising funds through the system of FIG. 1.

FIG. 28 illustrates an exemplary embodiment of a graphical user interface (GUI) portion pertaining to a communication tool that may find use for an organization raising funds through the system of FIG. 1.

FIG. 29 illustrates an exemplary embodiment of a graphical user interface (GUI) portion pertaining to a communication tool that may find use for an organization raising funds through the system of FIG. 1.

FIG. 30 illustrates an exemplary embodiment of a graphical user interface (GUI) portion pertaining to a communication tool that may find use for an organization raising funds through the system of FIG. 1.

### DETAILED DESCRIPTION

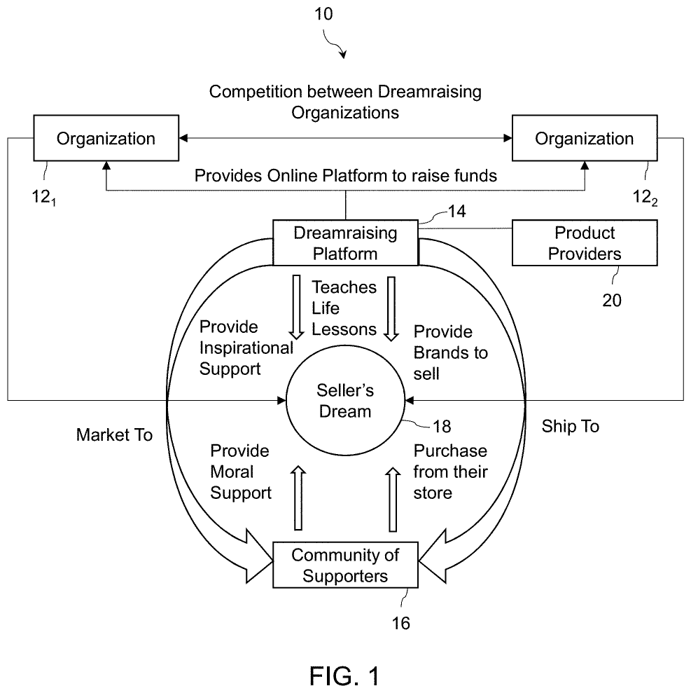

Referring to the drawings, wherein like reference numerals refer to the same or similar features in the various views, FIG. 1 is a block diagram and data flow view of an exemplary embodiment of a system 10 of raising funds, including philanthropic funds. The system may include a plurality of organizations 12 (two such organizations 12₁, 12₂ are shown in FIG. 1), a fundraising platform 14, a plurality of purchasers 16, a plurality of sellers 18, and one or more product providers 20.

The fundraising platform 14 may be provided as a website, the website provided by a server including a processor and a non-transitory, computer-readable memory, in an embodiment. Accordingly, one or more functions of the fundraising platform 14 described herein may be embodied in instructions in the memory that, when executed by the processor, result in a web page or web site having the underlying functionality. For example, one or more portions of a graphical user interface (GUI) of the fundraising platform 14 may be provided as web pages by a server.

Each of the organizations 12, sellers 18, and purchasers 16 may be associated with one or more mobile and/or non-mobile computing devices (e.g., personal computers, mobile phones, tablets, etc.) through which the organizations 12, sellers 18, and purchasers 16 may interact with one or more aspects of the fundraising platform 14, in an embodiment. For example, a server providing a GUI of the fundraising platform 14 may be in electronic communication with the computing devices of the organizations 12, sellers 18, and purchasers 16 for the organizations 12, sellers 18, and purchasers 16 to perform one or more of the tasks illustrated and/or described in this disclosure.

The fundraising platform 14 may be configured for assisting organizations 12 to raise funds through sellers 18 by selling products provided by the product providers 20 to individuals that support the sellers in order to raise funds to support dreams of sellers 18, in an embodiment. Accordingly, the fundraising platform 14 may be referred to herein as the “dreamraising” platform, the purchasers 16 may be referred to as supporters, and the organizations 12 may be referred to as dreamraising organizations.

The organizations 12 may be or may include one or more entities that wish to raise funds, such as charitable funds. For example and without limitation, the organizations 12 may include schools, youth sports teams, youth activity groups, and the like. The sellers 18 may be or may include one or more individuals or other entities that wish to raise funds for themselves or for the organizations 12. For example, the sellers 18 may include youths who attend or participate in one of the organizations 12. The purchasers 16 may be or may include one or more individuals or entities that purchase the sold by the sellers 18. The product providers 20 may include one or more providers of products appropriate for fundraising, such as foodstuffs (e.g., popcorn, candy, and the like), publications, etc.

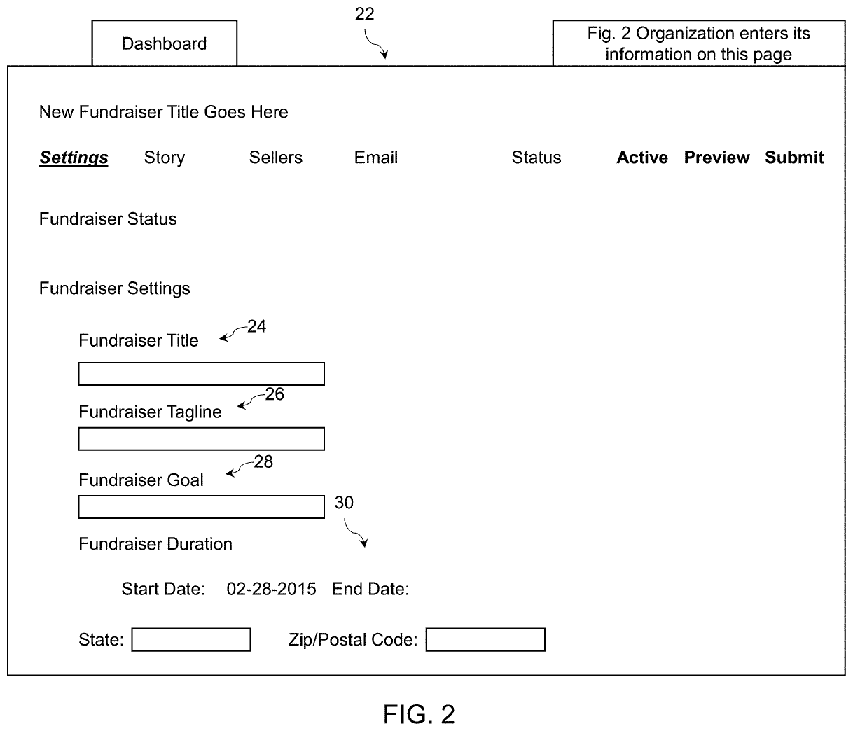

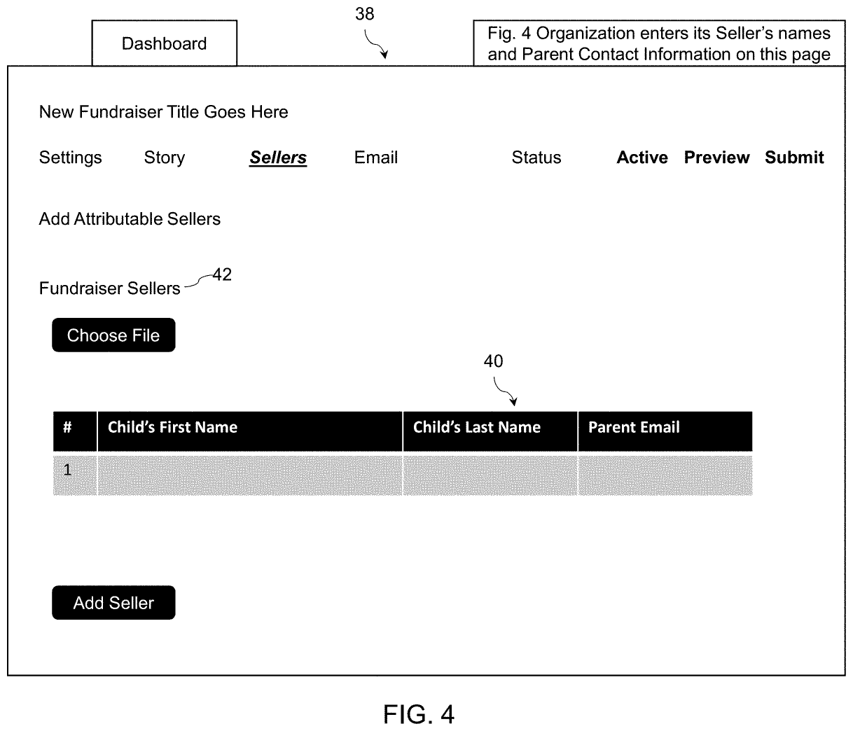

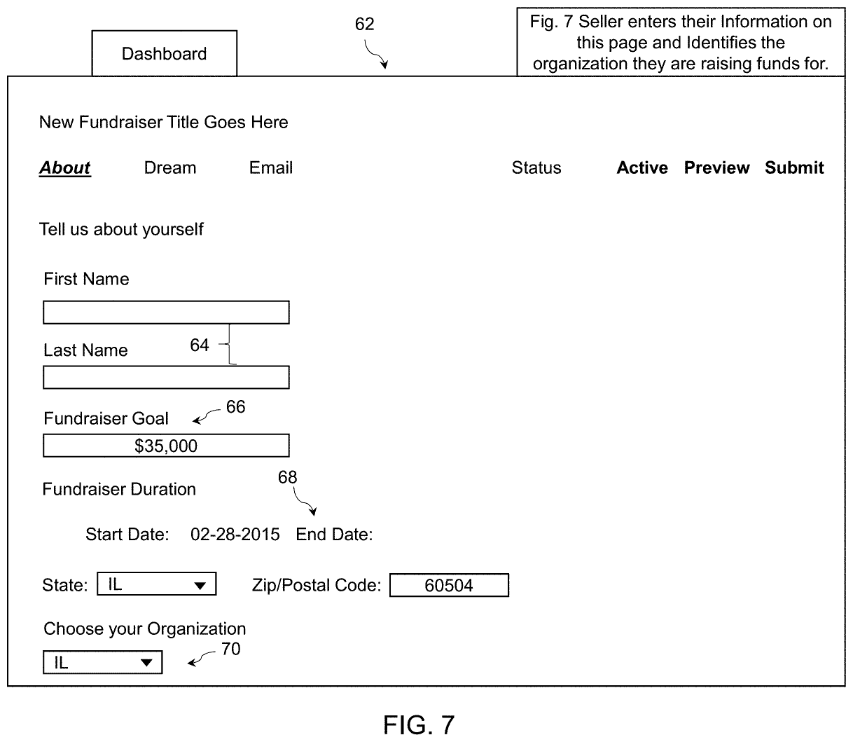

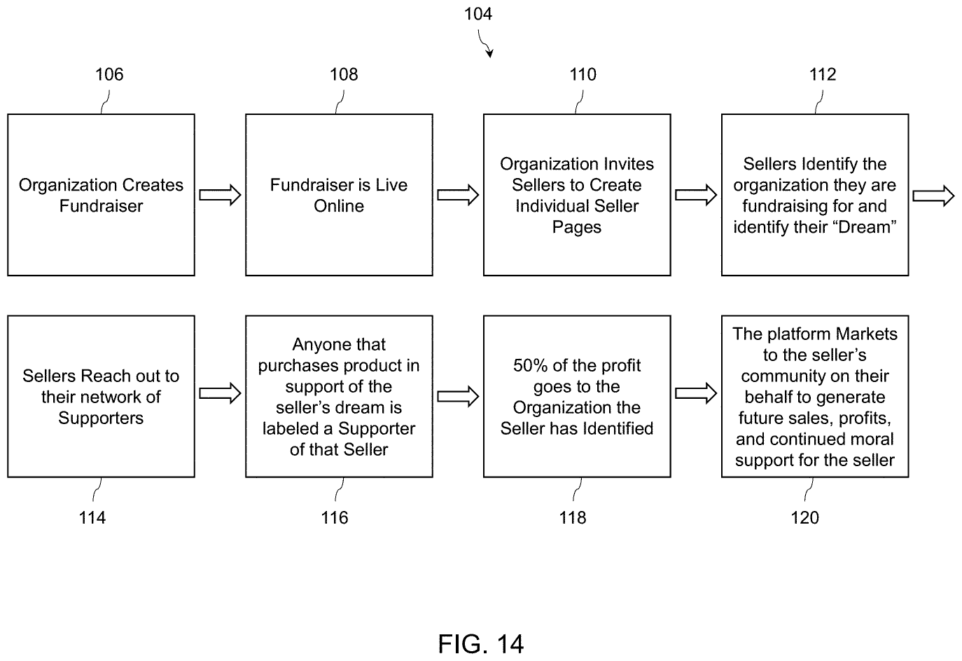

The fundraising platform 14 may provide a number of functions, which will be discussed in turn below. First, as will be described with respect to FIGS. 2-6, the fundraising platform 14 may provide an interface through which an organization 12 may organize fundraising activities. Second, as will be described with respect to FIGS. 7-13, the fundraising platform 14 may provide an interface through which a seller 18 may organize fundraising activities. Finally, the fundraising platform 14 may facilitate purchases of products from product providers 20, with certain proceeds from those purchases going to the sellers 18 and/or organizations 12 and other proceeds from those purchases going to the product providers 20. Such facilitation will be described with respect to FIGS. 14-16 from the respective points of view of organizations 12, sellers 18, and purchasers 16.

The fundraising platform 14 may provide a means by which an organization 12 may raise funds. In furtherance of this purpose, the fundraising platform 14 may provide web site interface portions (e.g., web pages) through which an organization may organize its fundraising. Information entered or provided by an organization through these interface portions may be used in interface portions for sellers and purchasers to contribute to the organization's fundraising campaign. Although interface portions will be described below with reference to individual web pages, it should be understood that the fundraising platform, and the interface portions provided, are not limited to separate, individual web pages.

First, as shown in FIG. 2, the fundraising platform may provide a fundraiser information entry interface portion 22. The fundraiser information entry page 22 may accept input from the organization about a new fundraising campaign, and thus may include portions such as a fundraiser title 24, a fundraiser tagline 26, a fundraiser goal 28 (e.g., dollar amount), a fundraiser duration 30, and/or other information.

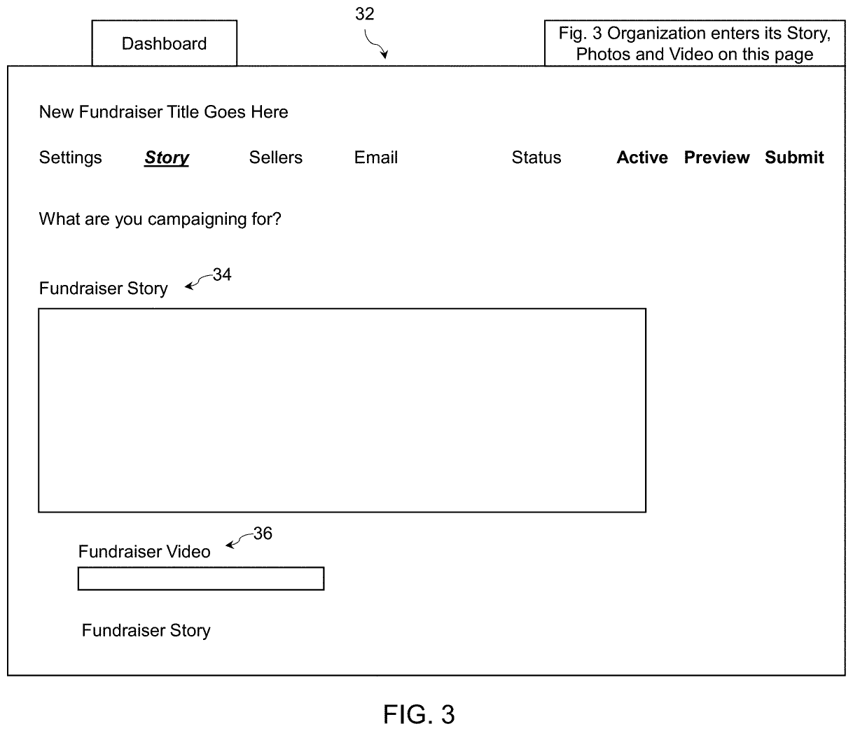

Referring to FIG. 3, the fundraising platform may further provide a fundraiser story entry interface portion 32, which may include portions such as a fundraiser description entry 34 and a fundraiser video attachment portion 36. The fundraiser story entry interface portion 32 may enable the organization to provide details of the fundraising campaign that inform sellers and purchasers of the purpose of the fundraising campaign (i.e., to “sell” the fundraising campaign itself).

The fundraising platform may further provide a seller designation page 38 for the organization. On the seller designation page 38, an organization may designate one or more sellers to be associated with that organization. The organization may designate sellers by entering information respective of one or more sellers in a seller entry portion 40, and/or by attaching a file including information of one or more sellers at a file attachment portion 42, in an embodiment. Sellers designated by the organization may be provided with invitations to associate with the organization, in an embodiment. When associated with an organization, a portion of the revenue of products sold by the seller may go towards the organization's fundraising campaign, in an embodiment.

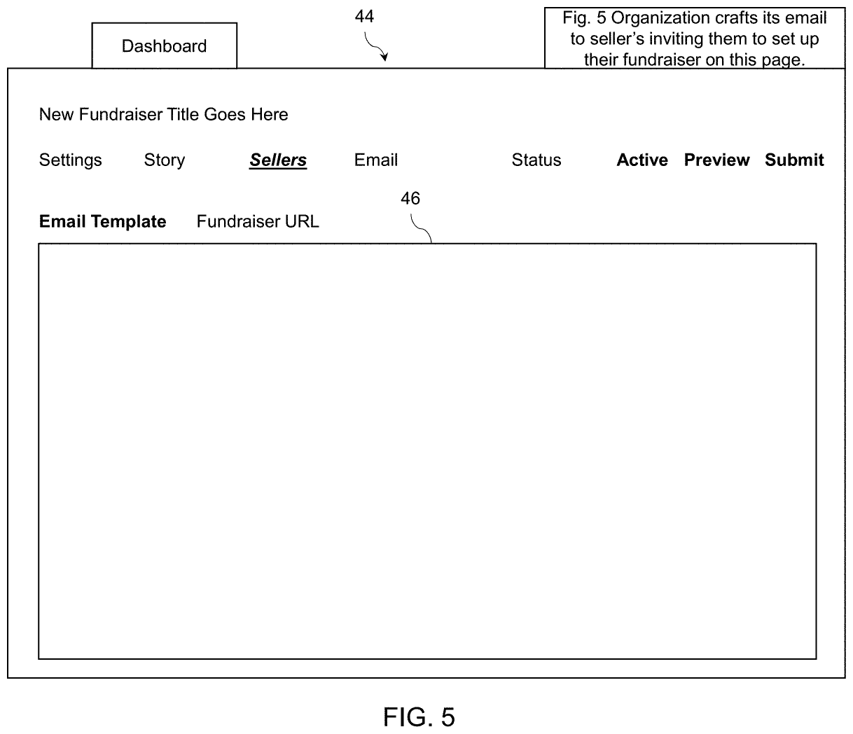

As noted above, sellers designated by the organization may receive an invitation to raise funds on the organization's behalf. FIG. 5 is an exemplary embodiment of an invitation interface 44 in which an organization may design an invitation to designated sellers. For example, in an embodiment, the invitation may be an email. Thus, the invitation interface 44 may include an email drafting portion 46. Once drafted by the organization, the invitation email may be sent automatically to designated sellers by the fundraising platform on behalf of the organization.

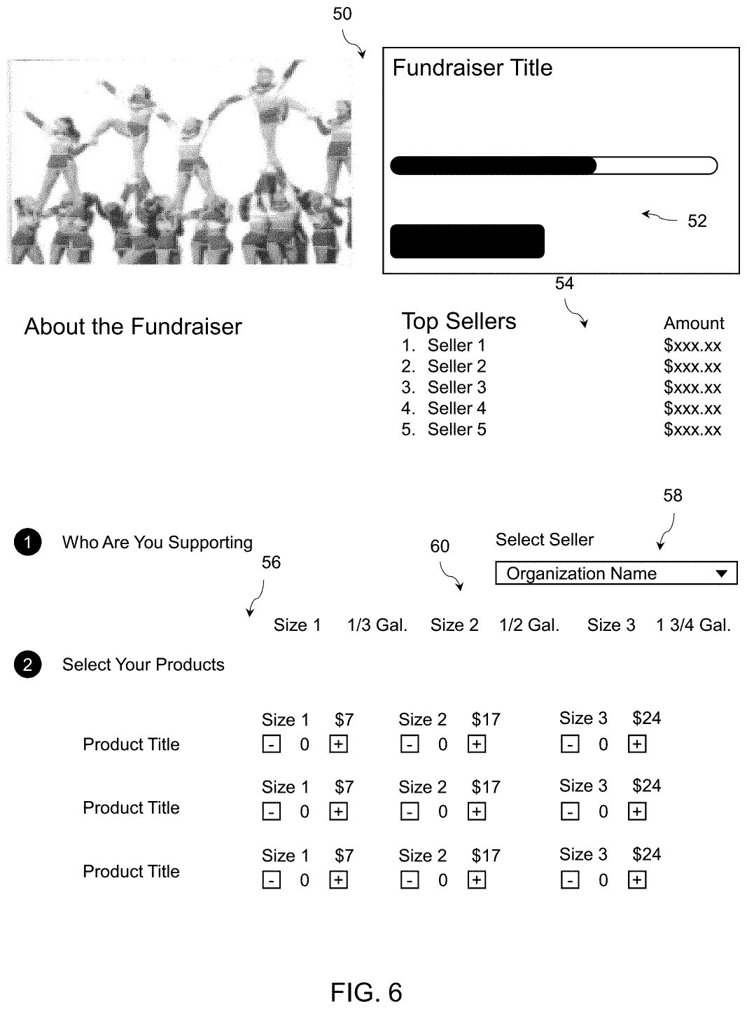

Once the organization sets up the fundraiser, including inviting designated sellers to associate with the organization, the organization's fundraiser may be provided with a fundraising web page by the fundraising platform. An exemplary embodiment of an organization fundraising page 50 is shown in FIG. 6. As shown in FIG. 6, the fundraising web page 50 may include a fundraiser information portion 52, a seller information portion 54, and a product sales portion 56. The fundraising information portion 52 may include some or all of the information about the fundraiser provided by the organization (e.g., as described above with respect to FIGS. 2 and 3). The seller information portion 54 may include a listing, ranking, etc. of one or more sellers associated with the organization. Finally, the product sales portion 56 may include a listing of products for sale. The products may be selectable or sortable by a purchaser by seller, in an embodiment. For example, the product sales portion 56 may include a seller selection portion 58 (e.g., menu) that allows a purchaser to select a seller from whom the purchaser would like to purchase. Responsive to a selection of purchaser, the fundraising platform may list on the page one or more products 60 offered for sale by the seller. Through the product sales portion 56, the fundraising platform may receive an order for one or more of the products 60 and payment for the order, in an embodiment. The fundraising platform may be configured to divert a portion of the proceeds from the sale to the organization, and a portion to the provider of the ordered product, in an embodiment.

The fundraising platform may also provide a means by which a seller may raise funds, either personally or on behalf of an organization. The fundraising platform may provide web site interface portions (e.g., web pages) through which a seller may organize fundraising or associate with fundraising by an organization. Information entered or provided by a seller through these interface portions may be used in interface portions for purchasers to contribute to the seller's fundraising.

First, the fundraising platform may provide a seller information entry interface 62, an exemplary embodiment of which is shown in FIG. 7. As shown in FIG. 7, the seller information entry interface 62 may include portions in which the seller may enter personal information such as a name 64, a fundraiser goal 66, a fundraiser duration 68, and an organization election 70, in an embodiment.

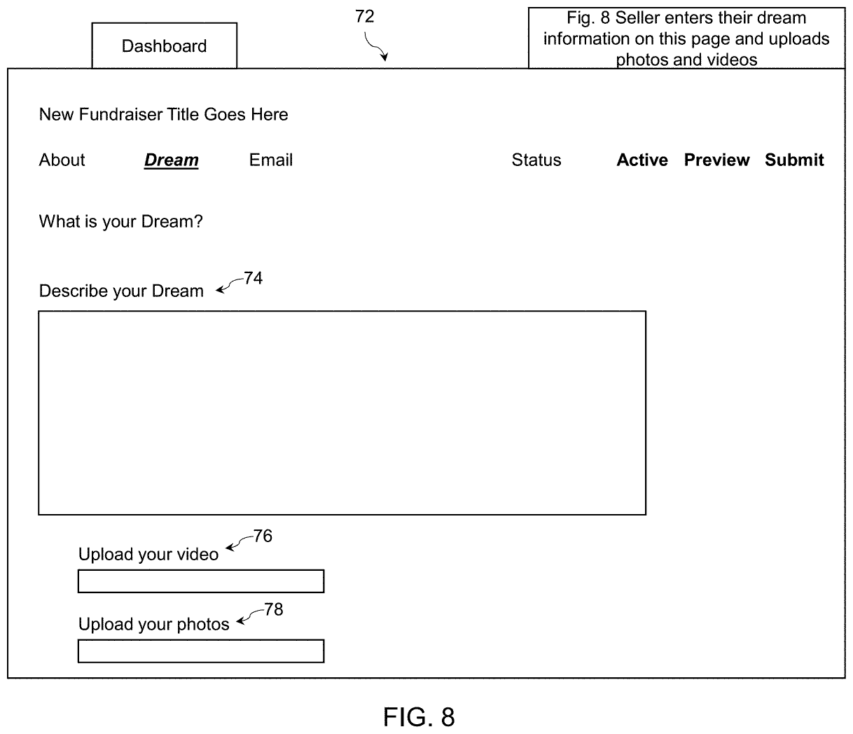

The fundraising platform may further provide a dream entry interface 72, an exemplary embodiment of which is shown in FIG. 8. The dream entry interface 72 may include portions in which the seller may enter a dream description 74, a video 76, one or more photos 78, and the like. The dream information entered by the seller may be used by the seller to convince purchasers to purchase products to support the seller's dream (i.e., the dream may “sell” the seller him or herself).

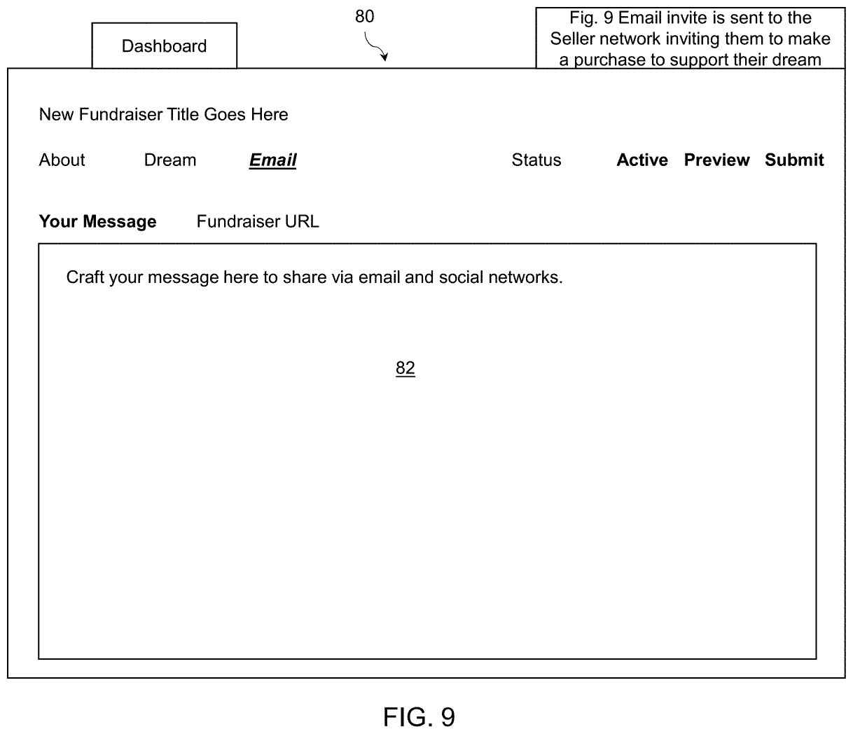

The fundraising platform may provide automatic communications with purchasers and potential purchasers on behalf of the seller, in an embodiment. Thus, the fundraising platform may provide a message entry portion 80 for the seller, shown in exemplary form in FIG. 9. The seller message entry portion 80 may allow the seller to input an email 82 or social network message that can be sent out to one or more potential purchasers. Such potential purchasers may be selected by the seller, in an embodiment, and/or by the fundraising platform, in an embodiment.

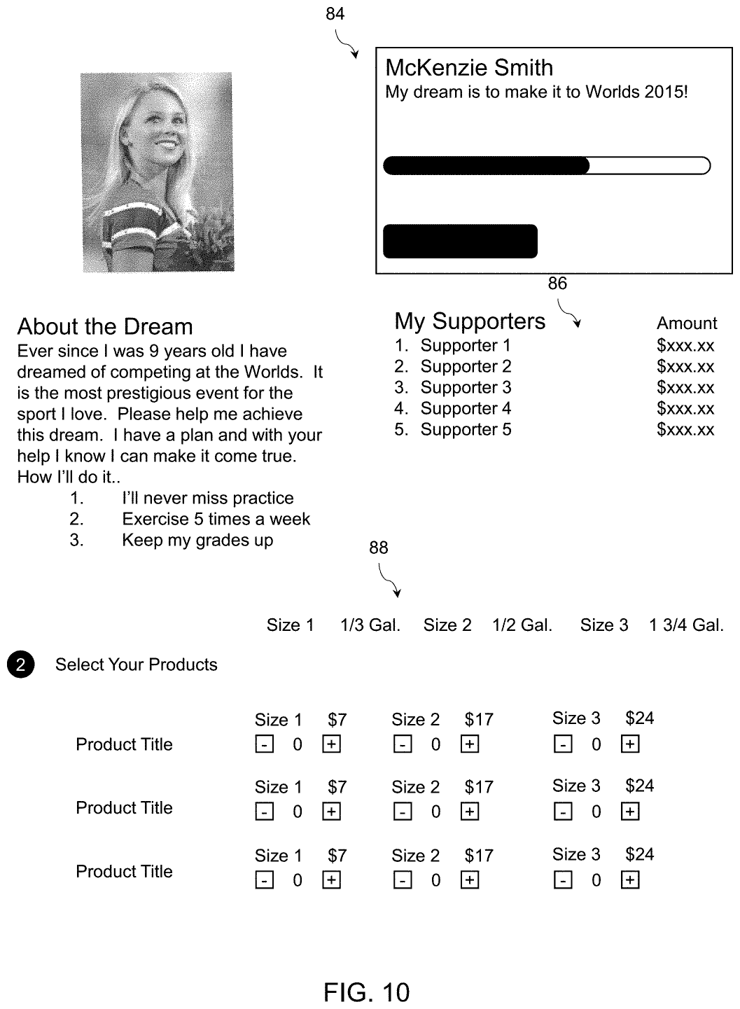

Once the seller has provided information regarding the seller and the seller's fundraising, the fundraising platform may provide the seller's information and fundraising in a web page specific to the seller. An exemplary embodiment of a seller web page 84 is shown in FIG. 10. The seller page 84 may include a seller information portion 86 and a product sales portion 88.

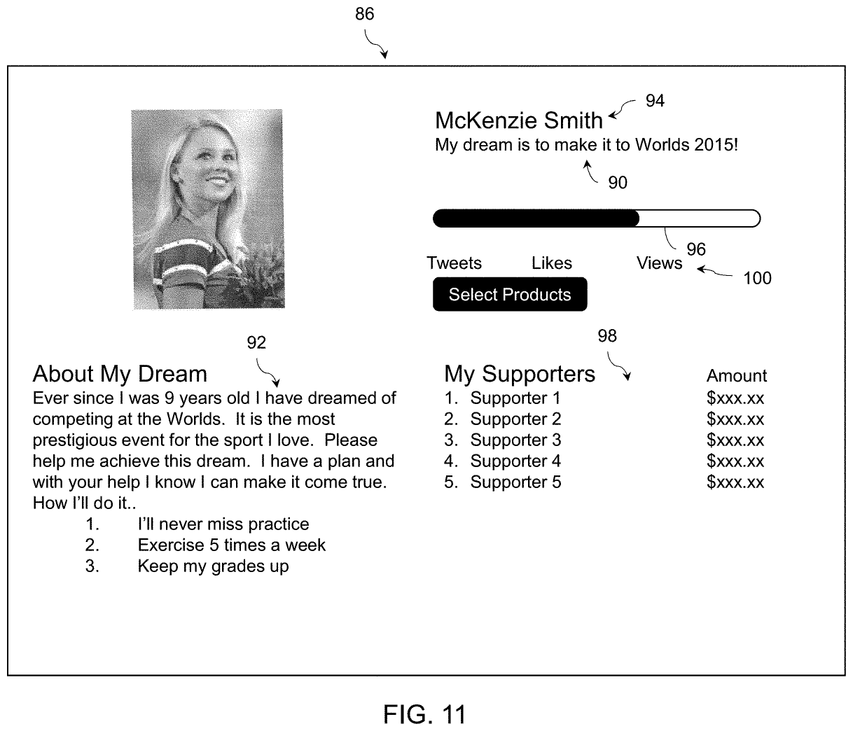

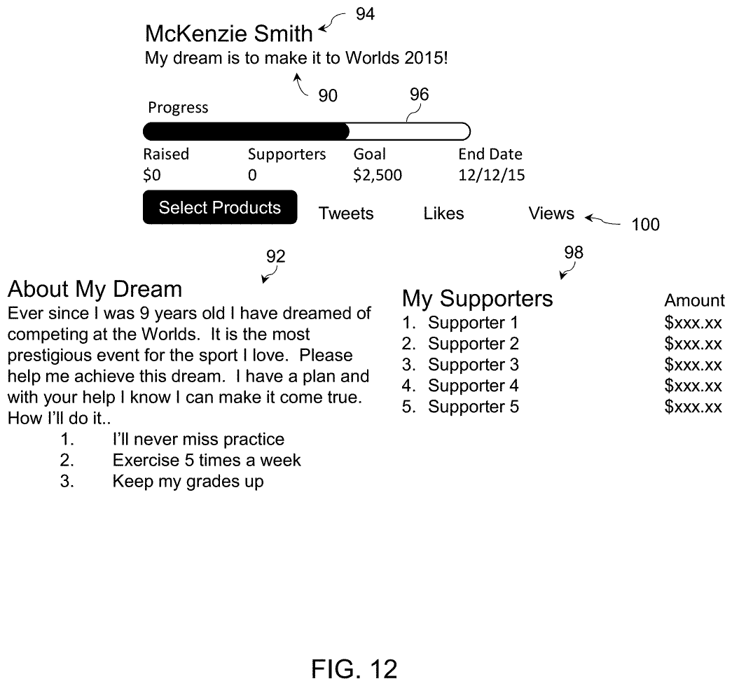

Referring to FIGS. 10-12 (where FIGS. 11 and 12 are enlarged views of portions of FIG. 10) as various embodiments, the seller information portion 86 may list the information provided by the seller, including the seller's dream 90, a description of the seller's dream 92, and the seller's name 94. The seller information portion may further include a fundraising goal progress 96 which may be in the form of a progress bar, in an embodiment, and a list of supporters 98 (i.e., purchasers who have purchased product sold by the seller). The supporters may be ranked, and/or the seller information portion 86 may further include a social sharing portion 100 that allows a viewer of the seller web page to connect the seller's web page to one or more social networks, such as FACEBOOK, TWITTER, PINTEREST, GOOGLE PLUS, GOOGLE MESSENGER, INSTAGRAM and SNAPCHAT. In an embodiment, the supporters or purchasers 98 will have the ability to leave encouraging messages and the like to the seller to support the seller and the seller's dream, possibly in a drop down menu (not shown).

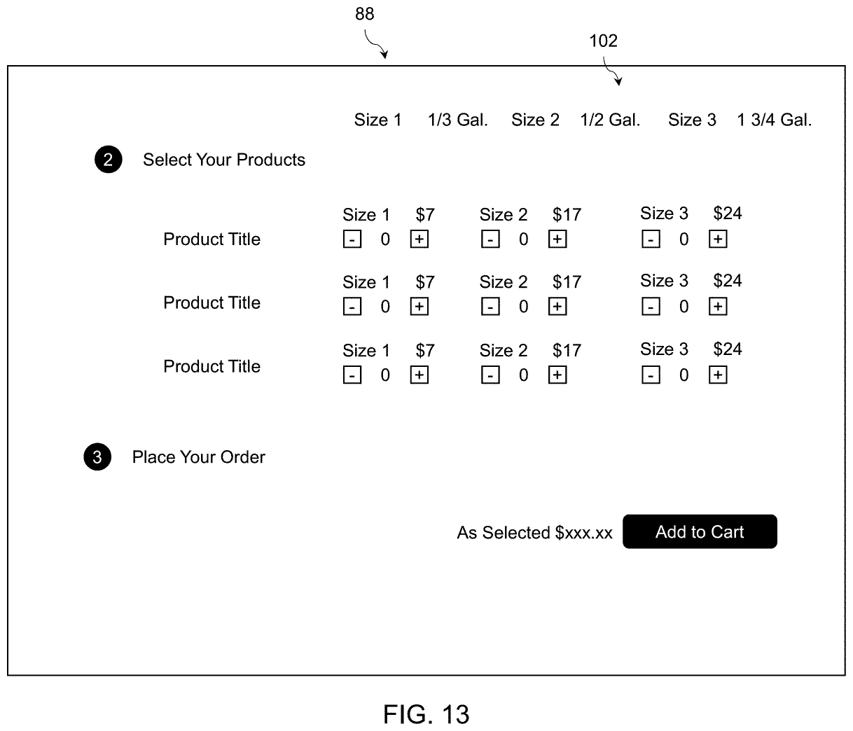

Referring to FIGS. 10 and 13 (where FIG. 13 is an enlarged view of a portion of FIG. 10), the product sales portion 88 of the seller page may include a listing of products 102 sold by the seller. Through the product sales portion 88, the fundraising platform may receive an order for one or more of the products and payment for the order, in an embodiment. The fundraising platform may be configured to divert a portion of the proceeds from the sale to the seller or to an organization with which the seller is associated, and a portion to the provider of the ordered product, in an embodiment.

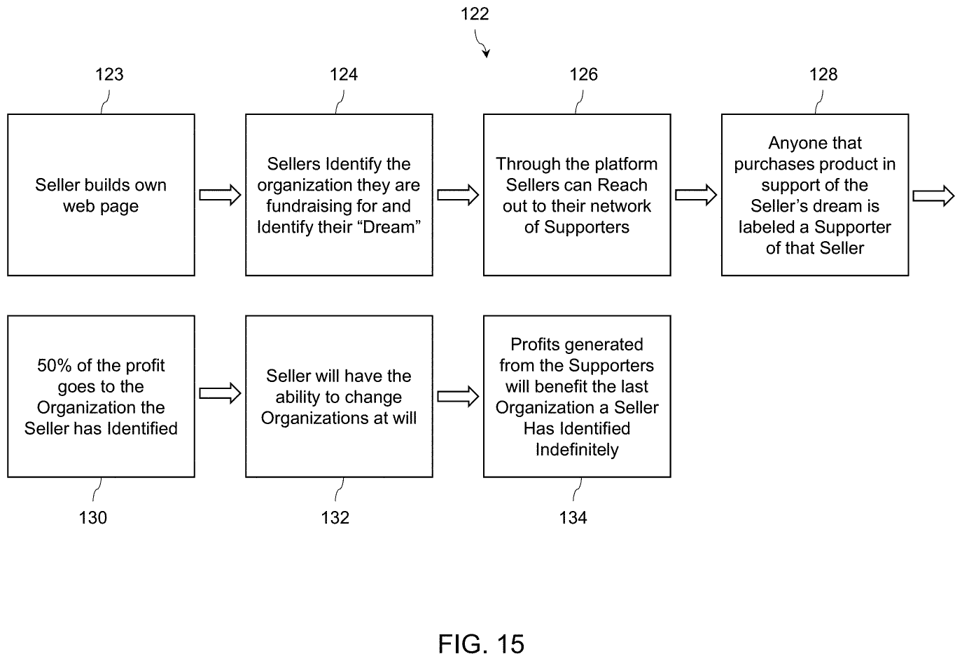

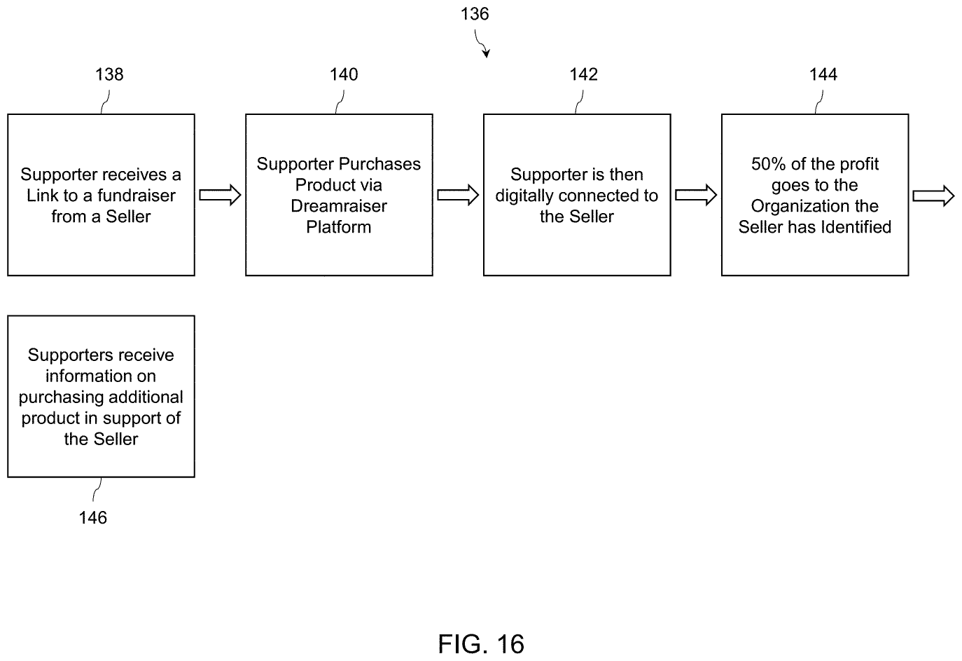

The organization-specific and seller-specific functions of the fundraising platform described above may be provided in furtherance of the sellers and organizations selling product to raise funds. A description of the process of selling and purchasing products to raise funds will now be described from the point of view of an organization with respect to FIG. 14, a seller with respect to FIG. 15, and a purchaser with respect to FIG. 16.

FIG. 14 is a flow chart illustrating a method 104 of fundraising through the fundraising platform of FIG. 1, from the point of view of an organization. One or more aspects of the method 104 may be performed by the fundraising platform, in an embodiment. At a first step 106 of the method, the organization may create a fundraiser (e.g., as described above with respect to FIGS. 2-4). At a further step 108, the fundraiser may “go live” (e.g., in the form of a web page, as shown in FIG. 6). At a further step 110, the organization may invite sellers to create individual seller pages within the organization's fundraiser (e.g., with the seller invitation interface shown in FIG. 5). At a further step 112, sellers invited by the organization may associate with the organization (alternatively, sellers may associate with the organization independent of an invitation from the organization) and identify their “dream.”

Once sellers are associated with the organization's fundraiser, at a further step 114 of the method, the sellers may reach out to their network of supporters (i.e., potential purchasers) to advertise the fundraiser. For example, the fundraising platform may send an email or other communication on the seller's behalf. In response, purchasers may purchase product through a seller's page provided by the fundraising platform.

Once a purchaser has purchased product, the method 104 may include a step 116 of labelling a purchaser as a supporter of the seller from whom the purchaser purchased product. The purchaser may then be advertised/shown on the fundraising platform as a supporter of that seller. In an embodiment, the method 104 may further a step 118 that includes dividing the money received for the purchaser's order. A portion of the money (e.g., 50%) may go to the organization, and the remaining portion may go to the provider of the purchased product.

The method 104 may further include a step 120 of the fundraising platform advertising the organization's fundraiser to potential purchases. Funding for the advertising may be provided by providers of the products to be sold, in an embodiment. This advertising may be provided throughout the fundraising process.

Referring to FIG. 15, from the seller's perspective, a method 122 of fundraising through the fundraising platform may begin with a step 123, in which the seller may build his or her own webpage, and then step 124, in which the seller identifies the organization that the seller is selling for and identifies his or her “dream” that will be supported by fundraiser sales. Next, at an outreach step 126, the seller may reach out to potential supporters through the fundraising platform.

At a purchasing step 128, purchasers may support the seller and the seller's dream by purchasing product through the fundraising platform and may then be labelled a supporter of the seller. In addition to purchasing products to support the seller and the seller's dream, supporters may be encouraged to purchase a subscription plan, to receive products over a period of time, such as monthly delivery of products sold as a three month, six month, nine month, or annual subscription plans, among other similar plans. As described herein, the fundraising platform can also be used to automatically or manually promote live events in support of the seller's dream. As such, through the platform, the sellers, supporters and organizations can be invited to participate in live events and/or competitions, all in support of the seller's dreams. At a further step 130, the fundraising platform may divide the money received for the purchaser's order, with a portion going to the organization with which the seller is associated and a portion going to the provider of the product ordered.

At a further step 132, the fundraising platform may provide the seller with the option to change organizations with which the seller is associated. For example, a seller may initially be associated with his or her school for a fundraiser by the school for a field trip, for example. Later, another organization with which the seller is affiliated—for example, an after-school sports team—may begin a fundraiser to travel to a tournament. At that time, the seller may wish that his or her sales be credited to the sports team, rather than to the school, so the seller may wish to be associated with the sports team instead of the school by the fundraising platform. Thus, the fundraising platform may accept a request from the seller to change association from the school to the sports team. When the fundraising platform receives such a request, the platform may disassociate the seller from the school and associate the seller with the sports team. Thereafter, as indicated by a further step 134, all sales by the seller will be credited to the sports team for as long as the seller is associated with the sports team by the fundraising platform.

FIG. 16 is a flow chart illustrating an exemplary method 136 of raising funds through the fundraising platform, from the point of view of the purchaser. The method 136 may begin at a step 138 of the purchaser (i.e., supporter) receiving a message from a seller, such as an email, containing a hyperlink to the seller's fundraising page. The purchaser may follow the hyperlink to arrive at the seller's fundraising page, an exemplary embodiment of which is shown in and was described with respect to FIGS. 10-13.

At the seller's fundraising page, the purchaser may order one or more products offered for sale by or through the seller, as indicated by a further step 140 in FIG. 16. When the purchaser makes the order, the fundraising platform may associate the purchaser with the seller, as indicated by a further step 142 in FIG. 16. In a further step 144, the seller may remit payment for the order (e.g., through the fundraising platform), and the payment may be divided (again, by the fundraising platform, in an embodiment) such that the organization with which the seller is associated receives a portion of the payment and the provider of the ordered products receives a portion.

As a result, the purchaser may be listed as a supporter of the seller on the seller's fundraising page and may receive other communications and information from the seller, as indicated in a further step 146 of the method. For example, when the seller switches association to another organization for a separate fundraiser, or when the organization with which the seller is associated begins a new fundraiser, the fundraising platform may send a message (e.g., email or message over a social network) to the purchaser to alert the purchaser and to request the purchaser's support.

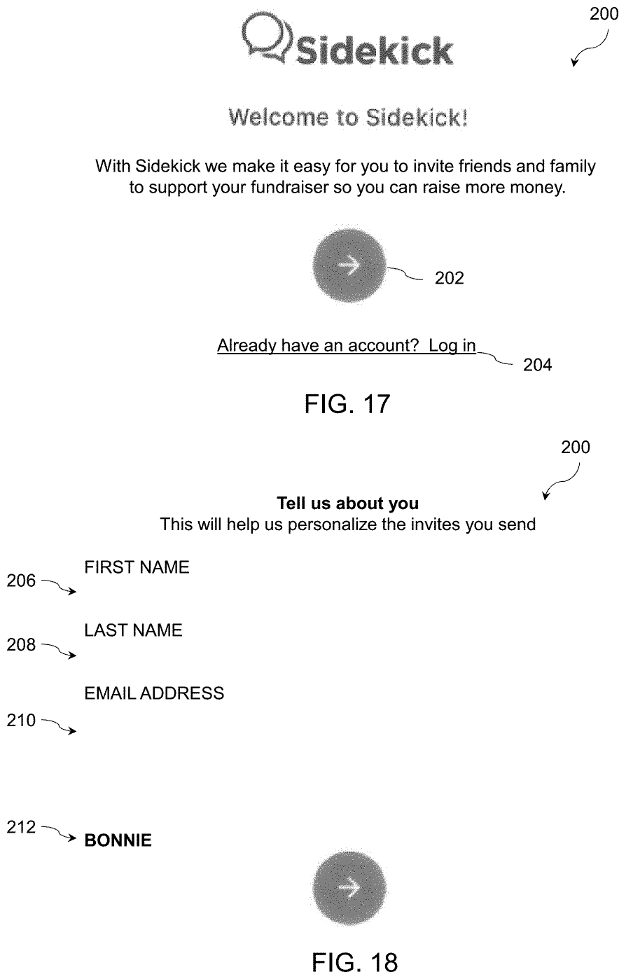

The fundraising platform 14 of FIG. 1 may also include a communication platform or tool 200 as set forth in exemplary fashion in FIGS. 17-30. Similar to the fundraising platform 14, the communication tool 200 can be provided as a website, the website provided by a server including a processor and a non-transitory, computer-readable memory, in an embodiment. Accordingly, one or more functions of the communications tool 200 described herein may be embodied in instructions in the memory that, when executed by the processor, result in a web page or web site having the underlying functionality. For example, one or more portions of a graphical user interface (GUI) of the communications tool 200 may be provided as web pages by a server.

The communication tool 200 can be used by participants, users or sellers 18 of the fundraising platform 14 for a particular fundraiser or for fundraising activities. The objective of the communications tool 200 is to allow the sharing of information pertaining to the particular fundraiser and to allow the user 18 to easily track sales of products or services.

In general and at the launch of the online fundraiser as detailed herein, the communication tool 200 shares information with parents and prospective participants or purchasers 16 in the fundraiser. Participants or users 18 of the platform 14 can login, add contacts, and share the link to the campaign fundraising page through email, text or social media. Users 18 can also import their contacts from their email service providers or contact management system, such as AOL, GOOGLE CONTACTS, APPLE ICLOUD, MICROSOFT OUTLOOK, YAHOO and others. Once the contacts are imported, drip marketing can be incorporated, or a drip campaign or similar automatic email campaign can be activated, sending information to the user's contacts alerting them of the fundraiser taking place. As sales are made, the platform can alerts the user and tracks the sales.

FIG. 17 illustrates the welcome page for users 18 of the exemplary communications platform or tool 200 incorporated into the fundraising platform 14. The exemplary welcome page allows the user 18 to either begin the registration process by selecting registration 202, or if previously registered, selecting login 204 to login back into the communications tool 200.

If the user 18 is registering for the first time, FIG. 18 illustrates the exemplary registration page where user's information is entered. Of course, as with all of the webpages described herein, the information entered and the report format can be different, depending on the needs of the fundraising platform 14, without limiting the scope of the invention.

The exemplary registration information includes the user's first name 206, last name 208, email address 210 and the particular name or reference 212 to be used for the fundraising activities. The name 212 may be the same or different than that of the person registering, for example if a parent registers for a child. The reference 212 will assist in personalizing invites sent at a later time.

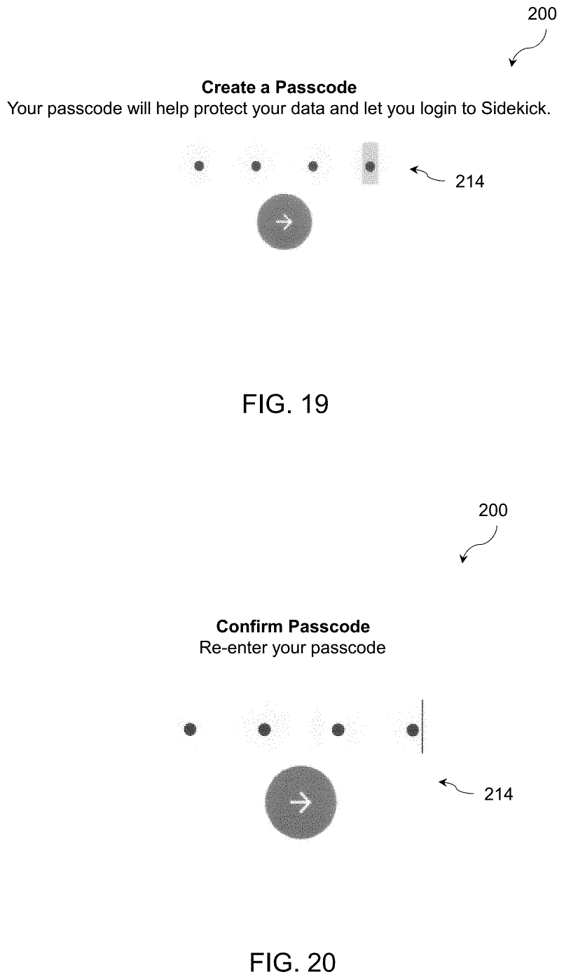

FIGS. 19 and 20 illustrate an exemplary passcode page to allow the user 18 to set up a passcode 214 for future access to the communication tool 200. The user 18 enters a passcode 214 in FIG. 19 and re-enters the same passcode 214 for authentication purposes in FIG. 20. The user 18 will use this passcode 214 for future access if they select the login 204 in FIG. 17.

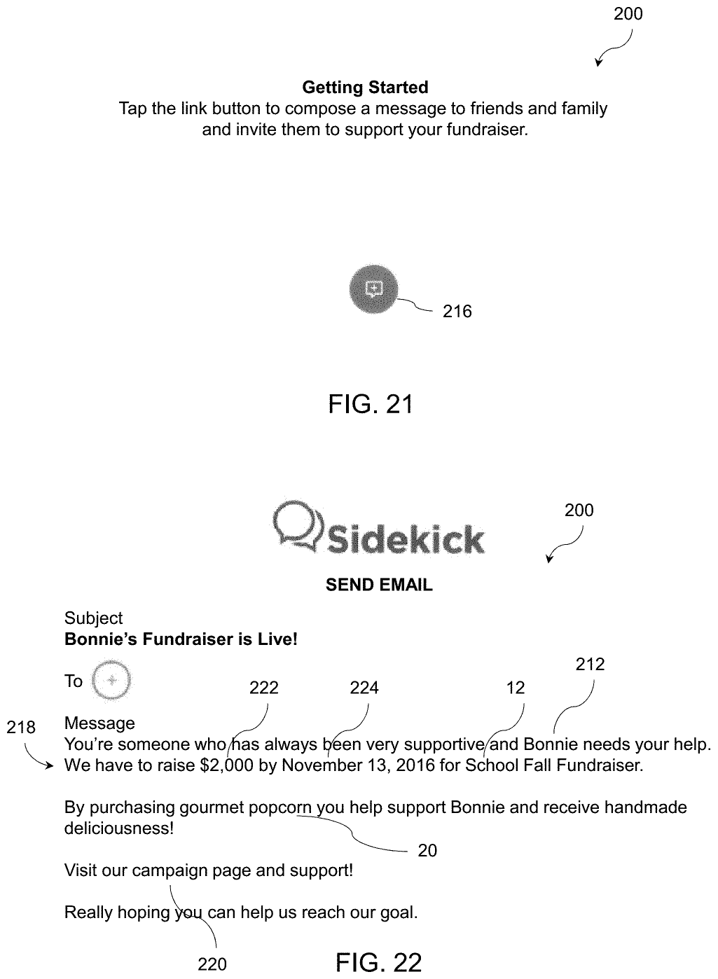

Once registered, the user 18 can get started setting up a message to be sent to potential purchasers 16. FIG. 21 illustrates an exemplary invite page in which the user 18 selects the invite button 216 to begin generating a message that will be sent to the potential purchasers 16 so they can support the user's fundraiser. Once the invite button 216 is selected, FIG. 22 illustrates and exemplary message page in which the user 18 is allowed to create the message 218 to be sent to the potential purchasers 16. The exemplary message may include the name of the participant 212, the organization 12 receiving some or all of the fundraising funds, the goods or product provider 20, a reference to additional information 220, a goal or amount 222, a date to reach that goal 224, among other information as necessary.

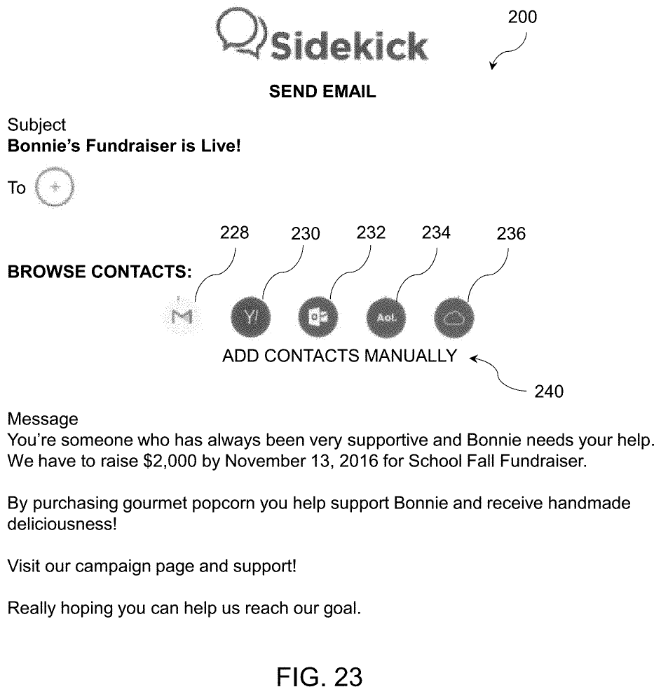

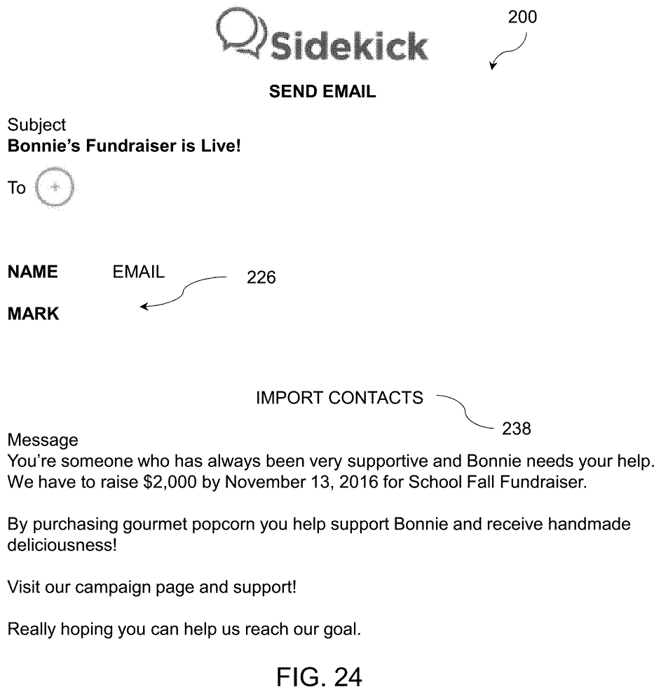

FIGS. 23 and 24 illustrate exemplary contact import pages in which the user 18 can import his or her contacts 226 (see FIG. 24 for example). As an example, FIG. 23 illustrates that the user 18 can access contacts 226 previously stored, and import those contacts from their email service providers or contact management system, such as GOOGLE CONTACTS 228, YAHOO 230, MICROSOFT OUTLOOK 232, AOL 234, APPLE ICLOUD 236 and others. Once imported, those contacts (and their email addresses) will be stored for sending the message 218. As a further example, FIG. 24 illustrates that to the extent the user 18 has not previously stored a particular contact 226, the communication tool 200 allows the user 18 to add that contact to the list. The user 18 can switch between importing contact 238 and manually adding contacts 240 by selecting the proper button and receiving the import contact page (FIG. 23) and the add contacts manually page (FIG. 24), respectively.

Once the contacts 226 have been imported into the communication tool 200, the message 218 will be sent to the potential purchasers 16 through their contact information 226 (such as emails). The message 218 can be sent once, or a number of times through a drip marketing campaign, or through similar automatic email campaigns. The potential purchasers 16 will be informed of the fundraising activities and will be allowed to participate by purchasing products or services. In addition to a customized fundraising page, the user 18 receives access to automated marketing provided by the fundraising platform 14 through the use of the communication platform 200. This fundraising platform 14 along with the communication platform 200 provides the user 18 with sophisticated digital marketing to increase sales and the ability to track funds raised.

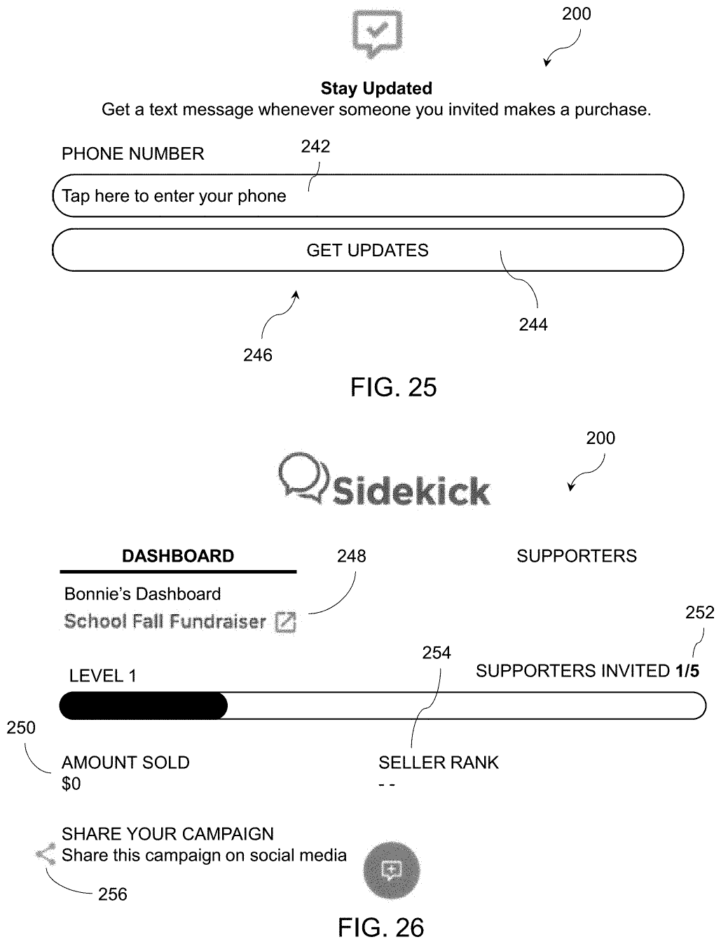

FIG. 25 illustrates an exemplary update generation page in which the user 18 enters the user's cell phone number (or similar unique access information) 242 and selects the get update button 244. Once completed, the user 18 will receive updates when a potential purchaser 16 makes a purchase through the fundraising platform 14, the total amount of sales to date and any other information set up through the communication tool 200. The user 18 can also select the maybe later button 246, which will send out a reminder at a later date to complete the update process.

FIG. 26 illustrates an exemplary update page in which the user 18 is updated as to the particular fundraiser 248, the amount received to date 250, the number of potential purchasers 16 invited to participate 252, a ranking 254 and a button to share the message 218 on social media 256. Of course, the information reported and the corresponding report format can be different, depending on the fundraising platform 14, without limiting the scope of the invention.

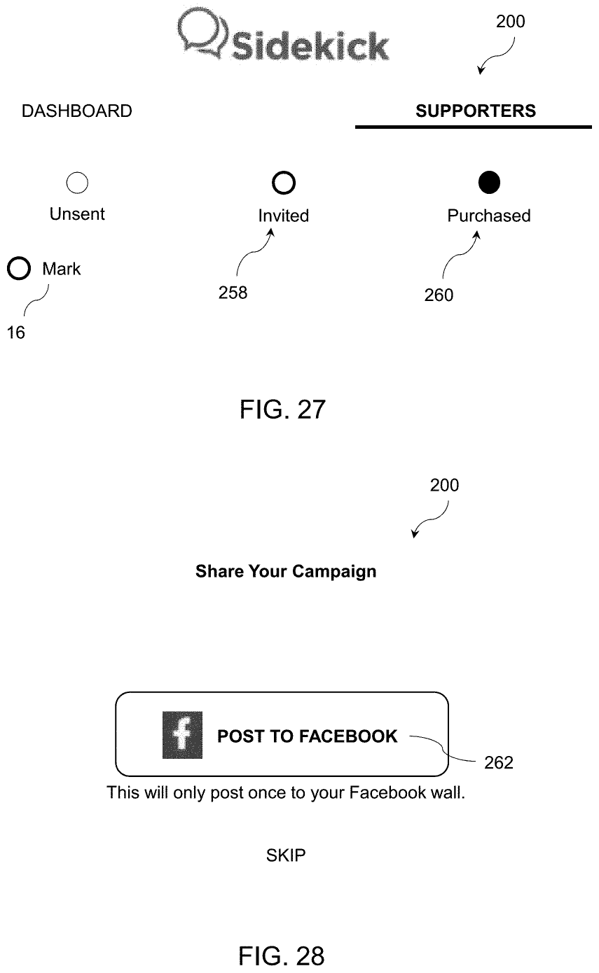

FIG. 27 illustrates an exemplary update page in which the user 18 is updated as to the potential purchasers 16 that have been added or invited 258 and whether they have made a purchase 260. This dashboard provides the user with easy access to this pertinent information to allow for individual follow up, as necessary.

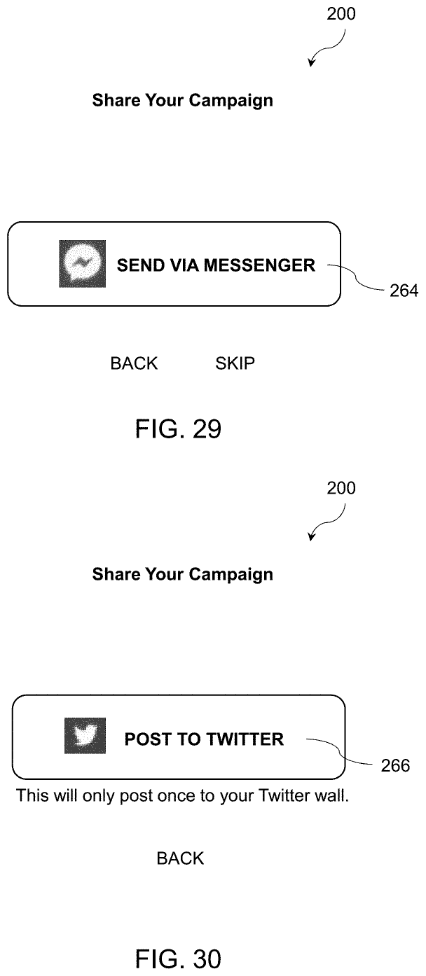

FIGS. 28-30 illustrate exemplary social media pages in which the user 18 is provided a simple way to send the message 218 to the various social media platforms. For example, the user 18 can post the message 218 to his or her FACEBOOK account 262 (FIG. 28), to his or her GOOGLE MESSENGER account 264 (FIG. 29), or to his or her TWITTER account 266 (FIG. 28), among the other social media platforms.

Accordingly, the user 18 is provided with a communication tool or platform 200 that allows the user 18 to send out a message 218 as to his or her fundraising activities to the imported or manually entered contacts 216, along with posting the message 218 to the various social media platforms 262, 264, 266, and then check on the progress of the fundraising activities to see how the fundraising is proceeding, or for follow up purposes.

It should be noted that, although the system and methods of this disclosure have been described with respect to embodiments in which sellers associate with organizations to raise funds to benefit the organizations, the fundraising platform may also find use in embodiments in which a seller raises funds for himself or herself. For example, a seller's “dream” may be an individual goal or activity, such as to travel to a tournament in an individual sport, for example. In such an embodiment, the fundraising platform may divide the funds received from a purchaser's order, divert a portion of the funds to the seller, and divert a portion of the fund to the provider of the goods. Further, in such an embodiment, the seller may have a page on the fundraising platform free of any organizational association.

It should also be noted that, although the system and methods of the present disclosure have been described with respect to embodiments in which sellers sell products, the fundraising platform may also fund use in embodiments in which the seller receives cash donations from purchasers, without any underlying product or service being purchased. In such an embodiment, the entirety of the donation may be directed to the seller, in an embodiment.

Still further, it should be understood that, in embodiments in which a seller sells products or services that a purchaser may desire on a regular basis, the purchaser may make regular purchases of those products or services through the fundraising platform to benefit the seller or the seller's associated organization even after the seller's or organization's fundraising campaign has ended. For example, if the seller sells popcorn to raise funds for a basketball team trip to a tournament, even after the needed funds are raised and after the tournament, a purchaser may purchase popcorn through the fundraising platform, and a portion of the funds from the order may be diverted to the basketball team for its needs. Thus, the dreamraising platform may offer fundraising for an indefinite period of time, in embodiments.

Raising funds according to the present disclosure may provide many advantages. First, fundraising today ignores the dreams of the children who are raising the funds. In contrast, dreamraising may leverage and communicate their dreams to create a supportive community. Second, fundraising today is generally done on a campaign basis and is finite. In contrast, dreamraising may never end. And generally in known fundraising, youth or youth organizations have to market and sell their own fundraisers. In contrast, dreamraising may market to their community on their behalf and generate sales, profits and continual moral support. Dreamraising may provide a professional marketing machine and leverage its own marketing intelligence and data to help drive profits for each seller child. Fourth, the dreamraising platform may allow an organization to invite a child to sell on behalf of the organization. Anyone that purchases in support of the child may be permanently linked to the child. Any future purchases may be credited to the organization that the child has identified. The child may change the organization in which he/she has identified and the profits will be credited to the new organization. Fifth, organizations may have the option to participate in fundraising competitions with other organizations. Sixth, the platform may teach valuable life lessons, for instance, the platform may generate activities or goals for the sellers. For example, the sellers may be given the opportunity to participate in a program in which they spend, save and donate the funds received in particular percentages. Again as an example, and not limiting the present disclosure, a 70/20/10 Spend/Save/Donate plan can be encouraged where sellers donate 10% of the money they raise, save 20% of the money they raise, and spend 70% of what they raise. Other goals and plans can be generated for the seller to choose.

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

Although numerous embodiments of this invention have been described above with a certain degree of particularity, those skilled in the art could make numerous alterations to the disclosed embodiments without departing from the spirit or scope of this disclosure. All directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of the any aspect of the disclosure. As used herein, the phrased “configured to,” “configured for,” and similar phrases indicate that the subject device, apparatus, or system is designed and/or constructed (e.g., through appropriate hardware, software, and/or components) to fulfill one or more specific object purposes, not that the subject device, apparatus, or system is merely capable of performing the object purpose. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

1-12. (canceled)

13. A method comprising:
receiving, from a first computing device associated with an organization, a request to create a fundraiser;
receiving, from the first computing device associated with the organization, an identification of a seller as being associated with the organization and the fundraiser;
receiving, from a second computing device associated with the seller, a request to create a web page associated with the seller;
receiving, from the second computing device associated with the seller, a plurality of potential purchasers associated with the seller, the association with the seller being based, at least in part, on the plurality of potential purchasers being listed as contacts of the seller on the second computing device, being associated with the seller on one or more social networks, or a combination thereof;
providing, to a third computing device associated with at least one potential purchaser of the plurality of potential purchasers, an invitation to access the web page;
causing, at least in part, a presentation of the web page on the third computing device associated with the at least one potential purchaser based, at least in part, on the at least one potential purchaser accepting the invitation, the web page including a list of a plurality of products from at least one provider for purchase by the at least one potential purchaser and a dream description, the dream description including a message, a video, one or more photos, or a combination thereof describing a purpose for the fundraiser specific to the seller for encouraging the at least one potential purchaser, the plurality of potential purchasers, or a combination thereof to purchase the plurality of products for supporting the fundraiser specific to the seller;
receiving, from the third computing device associated with the at least one potential purchaser, an order, the order identifying one or more products of the plurality of products purchased by the at least one potential purchaser and including payment for the one or more products;
providing a request to a fourth computing device associated with the at least one provider for fulfillment of the order, the fulfillment including at least providing the one or more products to the at least one potential purchaser;
distributing a first portion of the payment to the seller, the organization, or a combination thereof, and a second portion of the payment to the at least one provider; and
identifying the at least one potential purchaser as a supporter of the seller, the organization, or a combination thereof on the web page.

14. The method of claim 13, wherein the web page is specific to the seller out of a plurality of sellers associated with the organization.

15. The method of claim 13, wherein the seller and the organization are not a source of the plurality of products.

16. The method of claim 13, further comprising:
receiving an indication from the seller of a change in organization, the change in organization including a dissociation with organization and an association with a new organization; and
providing a message to the at least one potential purchaser indicating the change in organization of the seller.

17. The method of claim 16, further comprising:
providing a message to the plurality of potential purchasers indicating the change in organization of the seller.

18. The method of claim 13, wherein the organization is a school, a charity, or an athletic team, and the seller is a member of the organization.

19. The method of claim 13, further comprising:
receiving, from a fifth computing device associated with a purchaser, an order identifying one or more products of the plurality of products purchased by purchaser and including payment for the one or more products,
wherein the purchaser is not a potential purchaser of the plurality of potential purchasers.

20. The method of claim 19, further comprising:
identifying the purchaser as a supporter of the seller, the organization, or a combination thereof on the web page.

21. The method of claim 13, wherein the web page includes a description of the fundraiser and a goal of the seller.

22. The method of claim 13, wherein the invitation to access the web page is an e-mail containing a hyperlink to the web page.

23. The method of claim 13, further comprising:
causing, at least in part, a presentation of a dream entry interface on the second computing device associated with the seller, the dream entry interface including on or more portions for entering the dream description, the video, the one or more photos, or a combination thereof.
